(19) United States
(12) Patent Application Publication
(10) Pub. No.: US 2007/0018444 A1
(43) Pub. Date: Jan. 25, 2007

(54) Truck bed ballast bag

(76) Inventor: Michael Gibson, Stouffville (CA)

Correspondence Address: Elias C. Borges, Suite 406, 555 Burnhamthorpe Road, Toronto, ON, M9C 2Y3, CA

(21) Appl. No.: 11/185,894

(22) Filed: Jul. 21, 2005

(51) Int. Cl. B60R 9/00; B60R 7/00

(52) U.S. Cl. 280/759; 224/404

(57) ABSTRACT

A truck bed ballast for lying in the bed of a truck is disclosed. The ballast consists of a flat rectangular bag having four opposite sides and an upper and lower sheet. At least one of said sides has an elongated zipper for opening and closing the side of the bag. The bag is approximately 50 inches long between two of the opposite sides. The bag has four corners, each corner being provided with a strap for attachment of the bag to the bed of the truck. The bag is dimensioned to contain and secure at least two flat square concrete weights in abutting side to side alignment.

### FIELD OF THE INVENTION

The invention relates generally to truck bed ballast devices for adding weight to the bed of a truck.

### BACKGROUND OF THE INVENTION

It is well know to add weight to the bed of truck in order to obtain better traction during slippery road conditions. Numerous devices have been provided in the past for housing water or other ballast material. These devices have generally consisted of rigid box like devices which can be secured in the bed of the truck and which are dimensioned to contain a quantity of ballast material. While these ballast devices are effective in weighing down the back of the truck, they lack versatility. They are usually bulky and take up a considerable amount of truck bed space. Furthermore, due to their size, they may actually destabilize the truck by adding too much weight to one side of the truck bed. Finally, prior truck bed ballast devices tend to be fairly expensive, thereby discouraging their use. An improved truck bed ballast device which does not have these advantages is therefore required.

### SUMMARY OF THE INVENTION

In accordance with the present invention, there is provided a truck bed ballast for lying in the bed of a truck. The ballast consists of a flat rectangular bag having four opposite sides and an upper and lower flexible sheet. At least one of the sides of the bag has an elongated zipper for opening and closing the side of the bag. The bag is approximately 50 inches long between two of the opposite sides. The bag has four corners, each corner being provided with a strap for attachment of the bag to the bed of the truck. The bag is dimensioned to contain and secure at least two flat rectangular weights in abutting side to side alignment.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a top view of a truck bed ballast bag made in accordance with the invention.

FIG. 2. is a side view of a truck bed ballast bag made in accordance with the invention.

In the drawings like characters of reference indicate corresponding parts in the different figures.

### DETAILED DESCRIPTION OF THE INVENTION

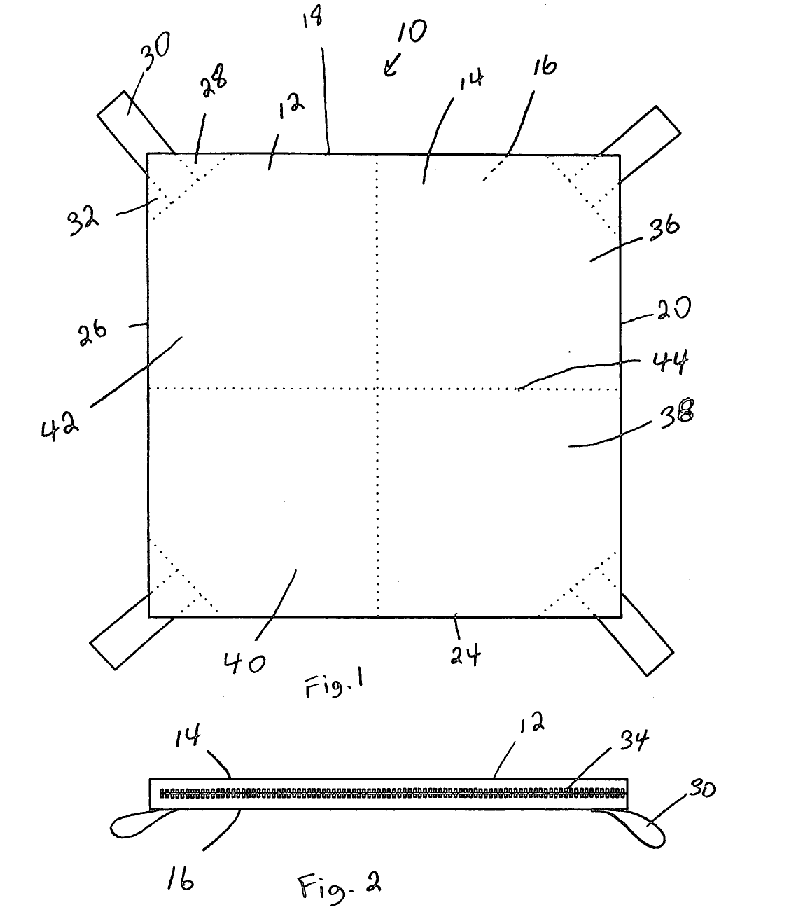

Referring firstly to FIG. 1, the truck bed ballast bag made in accordance with the present invention is shown generally as item 10 and consists of a rectangular bag 12 having upper sheet 14, lower sheet 16 and opposite sides 18, 20, 22 and 24. Sheets 14 and 16 are preferably made from a strong flexible material such as vinyl. At least one side of bag 12 is provided with an elongated zipper 34 for opening and closing the side. Preferably, zipper 34 extends along two adjacent sides such as sides 20 and 24 so that when the zipper is opened, the bag provides a large opening for receiving weights 36, 38, 40 and 42. Weights 36, 38, 40 and 42 are heavy rectangular weights made of a strong and heavy material such as concrete. Each weight has sides 24. Preferably the weights are square patio stones measuring 24 inches (two feet) on each side. Bag 12 is preferably square and measures approximately 50 inches on each side. Bag 12 is dimensioned such that weights 36, 38, 40 and 42 can be inserted into the bag and snugly retained in the bag when zippered up in abutting side to side alignment to form a large square.

Bag 12 has four corners 32. Each corner 28 is provided with a reinforcing tab 32 which is sewn into the bag to reinforce the corner. Strap 30 is attached to the reinforced corner and provides an attachment means for securely attaching the bag to the bed of the truck (not shown). Strap 30 may be a simple loop of strong material, or it may be an elastic cord. Hooks or other attachment elements (not shown) may be provided on the straps for more easily attaching the strap to the truck bed.

To use the bag to ballast the truck bed, the bag is first layered onto the truck bed (not shown) and secured to the bed by means of straps 30. The bag is then opened up by un-zipping zipper 34. Four patio stones 36, 38, 40 and 42 are then inserted into the bag and arranged in abutting side to side alignment. The bag is then zippered close. Alternatively, if patio stones of the appropriate size are not available, then the bag may be filled with any sort of heavy material such as crushed stone, gravel or sand. The large zippered opening makes it very easy to insert the material and layer it evenly. When fully zippered up, the flat bag retains the flat shape of the layered material.

The present invention has many advantages over the prior art. Firstly, since the bag is essentially a large rectangular bag having only one long zipper, the bag is very inexpensive to manufacture. Secondly, when the weights are added into the bag, the bag and weights act as a truck bed protector, protecting the truck bed from abrasion. The bag, being flexible, is also very easy to maneuver into position since it is quite light. Finally, when filled, the bag distributes the ballast weight evenly along and very close to the bottom of the truck bed. As a result, the truck will be more evenly balanced and should drive better.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A truck bed ballast for lying in the bed of a truck comprising: a rectangular bag made from first and second substantially rectangular sheets having sides and peripheral edges, the first and second sheets being firmly joined together at their peripheral edges along a first and a second adjacent sides, the first and second sheets being joined by a zipper at their peripheral edges along a third and forth adjacent sides, the bag being dimensioned to receive and contain four flat identical rectangular weights, the weights being dimensioned to fit snugly within the bag in abutting side to side alignment, the weights and bag being dimensioned and configured to fit within the truck bed.

2. The truck bed ballast of claim 1 wherein each of the weights is approximately 2 foot square.

3. The truck bed ballast of claim 1 wherein the weights are each made of concrete.

4. The truck bed ballast of claim 1 wherein the bag has four corners and the bag is provided with at least one attachment strap on each corner.

5. The truck bed ballast of claim 1 wherein weights are square and wherein the bag is dimensioned to contain the bags in abutting side to side alignment with each weight abutting two adjacent weights.

6. A truck bed ballast for lying in the bed of a truck comprising: a rectangular bag made from first and second substantially rectangular sheets, each sheet having four sides and peripheral edges, the first and second sheets being firmly joined together at their peripheral edges along at least two of said sides, the first and second sheets being joined by a zipper at their peripheral edges along at least one of said sides, the bag being dimensioned to receive and contain four flat identical rectangular weights, the weights being dimensioned to fit snugly within the bag in abutting side to side alignment such that the each weight abuts two weights, the weights and bag being dimensioned and configured to fit within the truck bed.

7. The truck bed ballast of claim 6 wherein the stones are each approximately two foot square.

8. The truck bed ballast of claim 7 wherein the stones are made of concrete.

9. The truck bed ballast of claim 6 wherein the bag has four corners, each corner having a strap for attachment of the bag to the bed of the truck.

10. The truck bed ballast of claim 6 wherein the first and second sheets are joined by a zipper at their peripheral edges along at least two adjacent sides.

11. A truck bed ballast for lying in the bed of a truck comprising: a flat rectangular bag having four opposite sides and an upper and lower sheet, at least one of said sides having an elongated zipper for opening and closing the side of the bag, the bad being approximately 50 inches long between two of the opposite sides, the bag having four corners, each corner being provided with a strap for attachment of the bag to the bed of the truck.

12. The truck bed ballast of claim 11 wherein the elongated zipper extends along two adjacent sides of the bag.

13. The truck bed ballast of claim 11 wherein the bag is substantially square and each side measures approximately 50 inches in length.

14. The truck bed ballast of claim 11 wherein the bag contains at least two flat rectangular weights, the weights each having four sides, the weights being contained in the bag in abutting side to side alignment.

15. The truck bed ballast of claim 11 wherein the bag further comprises four reinforcing tabs, each tab sewn into one corner of the bag for reinforcing the corner of the bag.

16. The truck bed ballast of claim 14 wherein the weights are flat square blocks measuring approximately 24 inches on each side.

17. The truck bed ballast of claim 11 wherein the bag is square and measures approximately 50 inches on each side.

18. The truck bed ballast of claim 17 wherein the bag contains four flat square weights, the weights each having four sides measuring approximately 24 inches in length, the weights being contained in the bag in abutting side to side alignment.

19. The truck bed ballast of claim 18 wherein the zipper extends along two adjacent sides of the bag.

20. The truck bed ballast of claim 19 wherein each corner of the bag is provided with a reinforcing tab sewn into the bag for reinforcing the corner.
